(19) United States
(12) Patent Application Publication
(10) Pub. No.: US 2008/0273597 A1
(43) Pub. Date: Nov. 6, 2008

(54) Method for searching for motion vector

(75) Inventors: Petr Kovalenko, Suwon-si (KR); Kwang-Pyo Choi, Anyang-si (KR); Han-Sang Kim, Suwon-si (KR); Bong-Gon Kim, Seoul (KR); Yun-Je Oh, Yongin-si (KR); Young-Hun Joo, Yongin-si (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 12/075,975

(22) Filed: Mar. 14, 2008

(30) Foreign Application Priority Data
May 2, 2007 (KR) 42809/2007

(51) Int. Cl. H04N 11/02

(52) U.S. Cl. 375/240.16; 375/E07.104; 375/E07.026

(57) ABSTRACT

Disclosed is video encoding technology, and more particularly a method for searching for a motion vector in a procedure of estimating a motion in video frames. The motion vector search method includes the steps of: individually calculating error energies of a center point and vertices of a search pattern in a search window used in a previous frame with respect to a center of the search window established in the current frame, thereby designating a motion vector candidate point; either determining the motion vector candidate point as a moving point of a motion vector, or calculating error energies of a pair of neighboring points and re-establishing a motion vector candidate point; and either determining the re-established motion vector candidate point as a moving point of a motion vector, or re-establishing a search pattern, re-checking the error energies of the center point, the vertices and the neighboring points, and determining a moving point of a motion vector.

### CLAIMS OF PRIORITY

This application claims priority to application entitled “Method For Searching For Motion Vector,” filed with the Korean Intellectual Property Office on May 2, 2007 and assigned Serial No. 2007-42809, the entire contents of which are incorporated herein by reference.

### BACKGROUND OF THE INVENTION

1. Field of the Invention

The present invention relates to video encoding technology, and more particularly to a method for searching for a motion vector in a procedure of estimating a motion in video frames.

2. Description of the Related Art

Generally, video data compression methods may be classified into lossless compression methods and lossy compression methods. A representative lossless compression method is an entropy coding method. The entropy coding is a compression method to reduce statistical redundancy from video data by expressing data values frequently used in an image with a short bit string and expressing rarely-used data values with a long bit string. Such a compression method has an advantage in that an image can be compressed without a loss in image quality, but has a disadvantage in that the compression rate is not high. A lossy compression method efficiently increases the image compression rate by removing redundant portions of video data. Generally, the lossy compression method compresses video data in consideration of spectral redundancy, spatial redundancy, temporal redundancy, statistical redundancy, etc. Specifically, based on the principle that human eyes are sensitive to contrast rather than chromaticity, video data is converted into a YCrCb (Y: Luminance, Cr: complementary red, and Cb: complementary blue) color system, thereby removing the spectral redundancy. Also, since adjacent pixels in an image have a high correlation therebetween, the image is converted into a spatial frequency domain through a discrete cosine transform (DCT) scheme or the like, and the converted data is quantized to remove the spatial redundancy. Since coefficients which have been subjected to the DCT and quantization process in the procedure of removing the spatial redundancy have high occurrence frequency statistically, frequently occurring coefficients statistically are expressed with a short bit string and rarely occurring components are expressed with a long bit string, so as to remove statistical redundancy. Finally, since a video is formed from a plurality of consecutive image frames, the image frames have a high correlation therebetween. Therefore, temporal redundancy between frames having a high correlation is removed among frames which are temporally adjacent to each other. Specifically, since a portion moving between temporally adjacent frames may be expressed by linear motion, the motion of a moving object is estimated by searching for a motion vector thereof. Then, a reference frame is created by reflecting the motion vector in a previous frame, and an error value between the reference frame and the current frame is detected.

Meanwhile, in the procedure of removing temporal redundancy, the motion vector search method includes a full search method and a high-speed search method. The full search method is to search for the best matching block by examining specific blocks, which are reference blocks of the current frame, within a search window of the previous frame. The full search method enables the best matching block to be obtained. However, since the full search method requires a large number of operations, a device having a complicated structure is required to perform the operations, and it takes a long time to search for a motion vector. The high-speed search method is to search for a motion vector by comparing the center point of a search window set within the current frame with several specified search points within a search window of a previous frame. Since the high-speed search method requires operations with respect to only the several specified search points, it has advantages in that the number of operations is reduced, and the time required to search for the motion vector is reduced. Accordingly, various studies are being conducted to develop a method capable of searching for a motion vector more quickly and exactly.

### SUMMARY OF THE INVENTION

Accordingly, the present invention provides a method and apparatus capable of searching for a motion vector quickly and exactly in a procedure of removing the temporal redundancy of video data.

In accordance with an embodiment of the present invention, there is provided a method for obtaining a motion vector (MV) of a search window established in a current frame during execution of a procedure for estimating a motion of a subsequent image frame, the method including: (a) individually calculating error energies of a center point and vertices of a search pattern (SP) in a search window used in a previous frame, with respect to a center of the search window established in the current frame; (b) designating a motion vector candidate point based on a result of the calculation performed in one of step (a) and (e); (c) when the designated motion vector candidate point corresponds to one of vertices in the search pattern, calculating error energies of a pair of neighboring points which are adjacent to the vertex designated as the motion vector candidate point; (d) re-establishing a motion vector candidate point based on a result of the calculation performed in step (c); (e) when one of the neighboring points is established as a motion vector candidate point in step (d), calculating error energies of vertices in a search pattern with respect to the neighboring point designated as the motion vector candidate point; and (f) either when the motion vector candidate point designated in step (b) corresponds to the center point, or when the motion vector candidate point re-established in step (d) corresponds to a vertex in the search pattern, determining the center point or the vertex as a moving point of the motion vector.

### BRIEF DESCRIPTION OF THE DRAWINGS

The above and other features and advantages of the present invention will be more apparent from the following detailed description taken in conjunction with the accompanying drawings, in which:

FIG. 1 is an example of a block diagram illustrating the configuration of a video encoder device to which the present invention is applied;

FIGS. 2A to 2D are examples of views illustrating a search pattern and neighboring points, which are used in the motion vector estimation method according to an exemplary embodiment of the present invention;

FIG. 3 is an example of a flowchart illustrating the procedure of the motion vector search method according to an exemplary embodiment of the present invention;

FIGS. 4A to 4G are examples of views illustrating the procedure of searching a moving point of a motion vector based on the motion vector search method according to an exemplary embodiment of the present invention;

FIGS. 5A to 5C are examples of views illustrating step-by-step a motion vector search procedure according to Comparison Example 1;

FIGS. 6A to 6C are examples of views illustrating step-by-step a motion vector search procedure according to Comparison Example 2;

FIGS. 7A to 7D are examples of views illustrating step-by-step a motion vector search procedure according to a first embodiment of the present invention;

FIGS. 8A to 8C are examples of views illustrating step-by-step a motion vector search procedure according to Comparison Example 3;

FIGS. 9A to 9D are examples of views illustrating step-by-step a motion vector search procedure according to Comparison Example 4;

FIGS. 10A to 10E are examples of views illustrating step-by-step a motion vector search procedure according to a second embodiment of the present invention;

FIGS. 11A to 11D are examples of views illustrating step-by-step a motion vector search procedure according to Comparison Example 5;

FIGS. 12A to 12F are examples of views illustrating step-by-step a motion vector search procedure according to Comparison Example 6; and

FIGS. 13A to 13E are examples of views illustrating step-by-step a motion vector search procedure according to a third embodiment of the present invention.

### DETAILED DESCRIPTION OF THE INVENTION

Hereinafter, embodiments of the present invention will be described with reference to the accompanying drawings. In the below description, many particular items such as a detailed component device are shown, but these are given only for providing the general understanding of the present invention. It will be understood by those skilled in the art that various changes in form and detail may be made within the scope of the present invention.

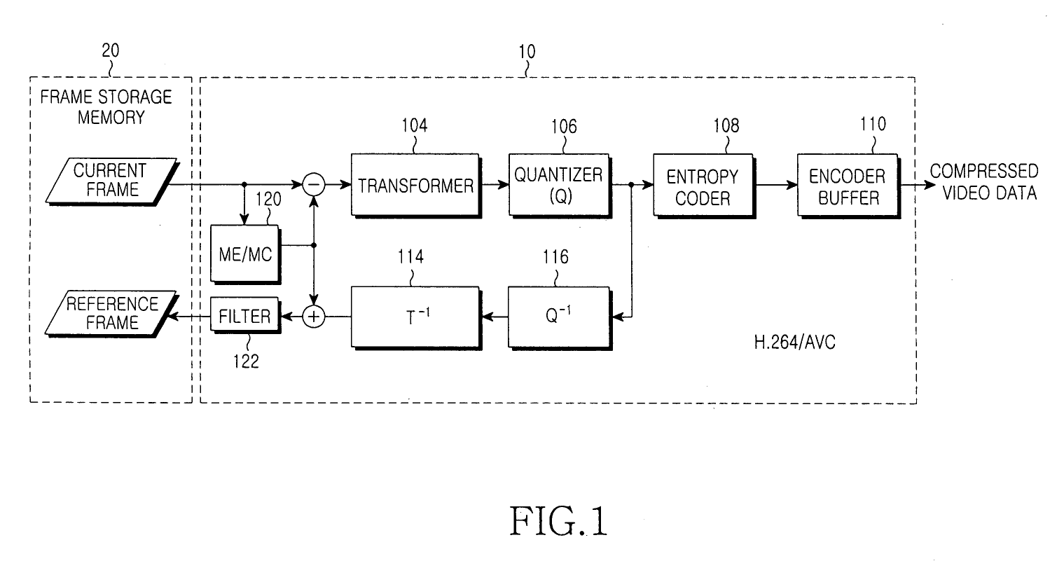

FIG. 1 is a block diagram illustrating the configuration of a video encoder device to which the present invention is applied. The video encoder device includes a general H.264/AVC (Advanced Video coding) encoder 10 for receiving video frame sequences and outputting compressed video data, and a frame storage memory 20 for storing frames.

First, the construction and operation of the encoder 10 will be described in more detail. The encoder 10 includes a transformer 104, a quantizer 106, an entropy coder 108, an encoder buffer 110, an inverse quantizer 116, an inverse transformer 114, a motion estimation/motion compensation (ME/MC) unit 120, and a filter 112.

The transformer 104 converts spatial domain video information into frequency domain data (e.g., spectral data). In this case, the transformer 104 typically performs a Discrete Cosine Transform (DCT) to generate spatial-frequency-domain DCT coefficient blocks by the macroblock from original blocks.

The quantizer 106 quantizes blocks of spectral data coefficients output from the transformer 104. In this case, the quantizer 106 applies a predetermined scalar quantization to the spectral data according to a step size change based on each frame.

The entropy coder 108 compresses output from the quantizer 106 as well as specific supplementary information (e.g., motion information, spatial extrapolation mode, and quantization parameter) of a corresponding macroblock. Generally applied entropy coding technology includes arithmetic coding, Huffman coding, run-length coding, and Lempel Ziv Welch (LZW) coding. The entropy coder 108 typically applies different coding technologies to different types of information.

Concurrently, when the current frame restructured as described above is necessary for subsequent motion estimation/compensation, the inverse quantizer 116 and inverse transformer 114 operate. The inverse quantizer 116 performs inverse quantization for quantized spectral coefficients. The inverse transformer 114 generates an inverse difference macroblock by performing an inverse DCT for data output through the inverse quantizer 116. Data output through the inverse transformer 114 is obtained through inverse conversion of data which has been converted by the transformer 104 and the quantizer 106, and thus is not identical to the original macroblock of the input frame due to influence of a signal loss, etc.

When the current frame is an interframe, the ME/MC unit 120 combines the reconstructed inverse difference macroblock and a prediction macroblock so as to generate restructured macroblocks (hereinafter, referred to as a “reference frame”). The restructured macroblocks are stored in the frame storage memory 20 in order to be available for use in the estimation of the next frame. In this case, the ME/MC unit 120 searches for an M×N sample area of the reference frame which is identical to an M×N sample block of the current frame, and performs block-based motion estimation therefor.

In addition, the ME/MC unit 120 performs motion estimation based on a motion vector search method which will be described later.

First of all, terms used in the present invention will be defined prior to explaining the motion vector search method according to an exemplary embodiment of the present invention.

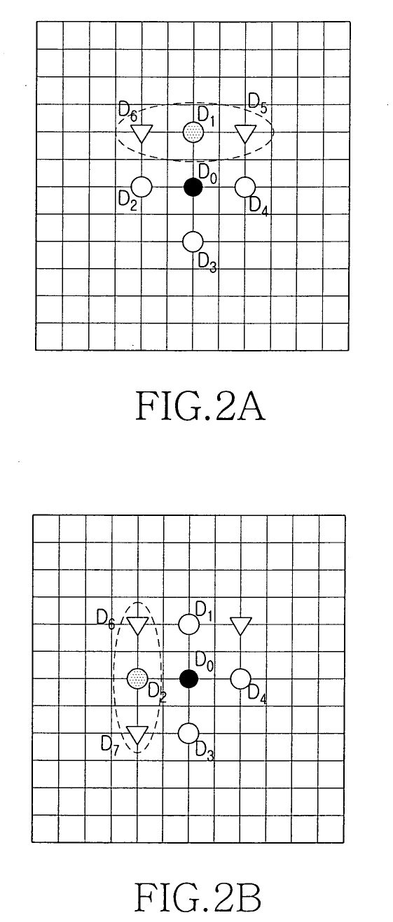

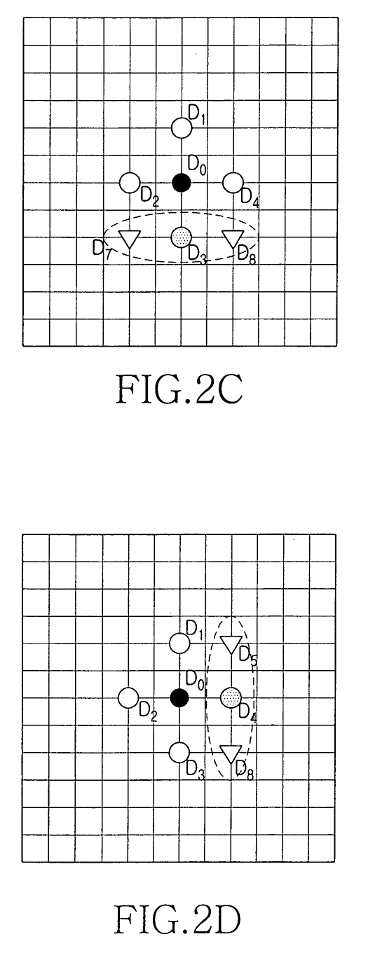

FIGS. 2A to 2D are examples of views illustrating a search pattern and neighboring points, which are used in the motion vector estimation method according to an exemplary embodiment of the present invention.

The search pattern includes a center point and at least two pairs of vertices. Each pair of vertices is located in such a manner as to face each other with respect to the center point. Also, the vertices are located such that a first line connecting one pair of vertices and a second line connecting the other pair of vertices are perpendicular to each other at the center point. That is, referring to FIG. 2A, when an O point “D₀” is a center point, vertices may be a first point D₁, a second point D₂, a third point D₃, and a fourth point D₄, as those in the typical large diamond search pattern (LDSP).

Although the exemplary embodiment of the present invention is described regarding the typical large diamond search pattern as a search pattern, the present invention is not limited thereto. For example, the present invention will employ a square-shaped search pattern with respect to a center point.

A pair of neighboring points (neighboring a reference vertex) may be points horizontally displaced by a distance between the center point and the vertex, from a pair of vertexes. That is, when it is assumed in FIG. 2A that a reference vertex is the first point D₁, vertices neighboring the first point D₁, which is the reference vertex, are the second point D₂ and fourth point D₄. Then, a pair of neighboring points is a fifth point D₅ and a sixth point D₆, which are horizontally displaced by the distance between the center point and the first point D₁, from the second point D₂ and fourth point D₄ toward the first point D₁. Similarly, referring to FIGS. 2B, 2C and 2D, when a reference vertex is the second point D₂, third point D₃, or fourth point D₄, a pair of neighboring points are defined as the sixth point D₆ and a seventh point D₇, the seventh point D₇ and an eighth point D₈, or the eighth point D₈ and a ninth point D₉, respectively.

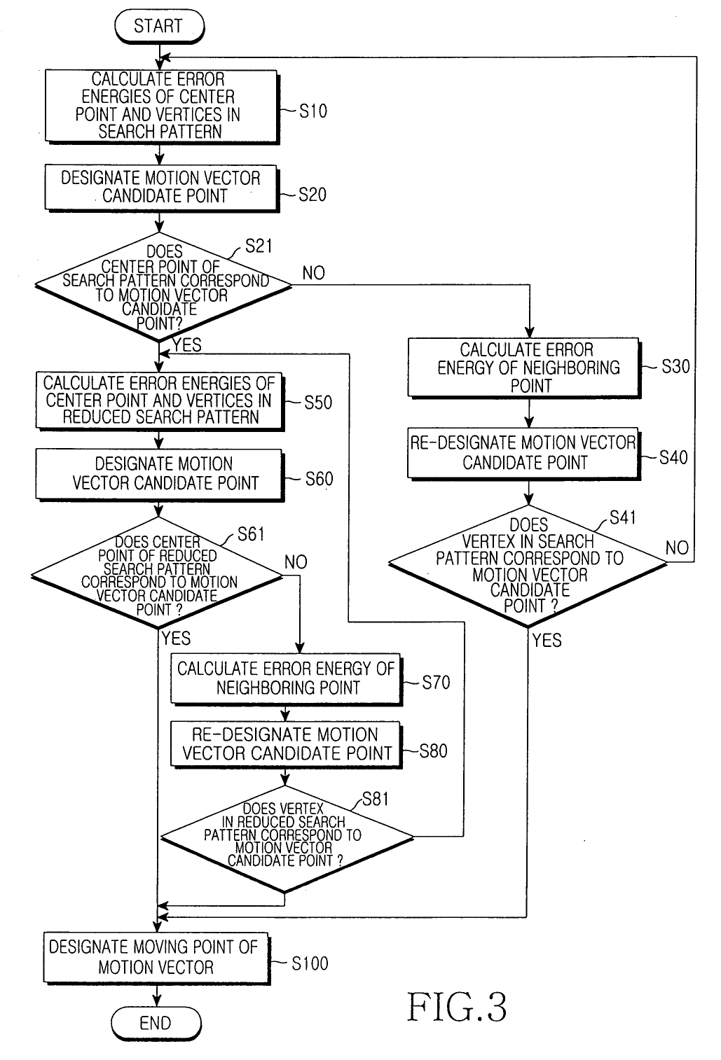

FIG. 3 is an example of a flowchart illustrating a procedure of a motion vector search method according to an exemplary embodiment of the present invention.

In step 10, the error energies of a center point and four vertices located in a diamond pattern around the center point are calculated. Then, among the calculated error energies of the five points, a point having the lowest error energy is designated as a motion vector candidate point (step 20). In this case, if one of the vertices is designated as the motion vector candidate point (step 21-N), the error energies of a pair of neighboring points with respect to the vertex designated as the motion vector candidate point are calculated (step 30). Next, among the vertex designated as a motion vector candidate point in step 20 and the pair of neighboring points, a point having the lowest error energy is newly designated as a motion vector candidate point (step 40). When one of the neighboring points is designated as a motion vector candidate point as a result of the step 40, the neighboring point designated as a motion vector candidate point is regarded as a center point, and then steps 10, 20, 21, 30, 40 and 41 are repeated. In this case, the steps 10, 20, 21, 30, 40 and 41 are continuously repeated either until either an initially-established center point is designated as a motion vector candidate point, or until the center point of a primarily-designated motion vector candidate point is again designated as a motion vector candidate point.

In contrast, either when a first-established center point is designated as a motion vector candidate point (step 21-Y), or when a primarily-designated motion vector candidate point is again designated as a motion vector candidate point (step 21-Y or step 41-Y), the corresponding point is designated as a moving point of a motion vector (step 100).

In addition, the motion vector search method further includes a motion vector search procedure (steps 50, 60, 61, 70, 80 and 81) having a reduced search pattern. In this case, steps 50, 60, 61, 70, 80 and 81, are performed before step 100 in the same manner as steps 10, 20, 21, 30, 40 and 41, respectively, except that steps 50, 60, 61, 70, 80 and 81 are performed based on a reduced search pattern in order to search for a motion vector. In this case, the reduced search pattern has a form obtained by reducing the size of a search pattern, in which vertices in the reduced search pattern have the same pattern as those of a primary search pattern, except that the distance between a center point and each vertex in the reduced search pattern is established to be different from that in the primary search pattern. For example, when the primary search pattern is a typical large diamond search pattern, the reduced search pattern may be a typical small diamond search pattern (SDSP).

In particular, in step 50, similarly to step 10, when a motion vector candidate point is designated through step 21-Y or step 41-Y, the error energies of vertices in a reduced search pattern with respect to the designated motion vector candidate point are calculated. Then, in step 60, similarly to step 20, a point having the lowest error energy among the center point and vertices is designated as a motion vector candidate point, by comparing the error energies of the center point and vertices with each other. In this case, when the point designated as a motion vector candidate point corresponds to the center point of the reduced search pattern (step 61-Y), the motion vector candidate point is designated as a moving point of a motion vector (step 100). In contrast, when the point designated as a motion vector candidate point corresponds to a vertex in the reduced search pattern (step 61-N), step 70 is performed. Steps 70 and 80 are similar to steps 30 and 40, respectively. That is, in steps 70 and 80, the error energies of the neighboring points of the vertex in the reduced search pattern are calculated. Then, a motion vector candidate point is newly designated by using the calculated value (step 80). When the point designated as a motion vector candidate point according to such a manner corresponds to a vertex in the reduced search pattern (step 81-Y), step 100 is performed. In contrast, when the point designated as a motion vector candidate point corresponds to a neighboring point with respect to a vertex in the reduced search pattern (step 81-N), steps 50, 60, 61, 70 and 80 are repeated.

Concurrently, in the motion vector search method according to an exemplary embodiment of the present invention, step 10 is performed to calculate the error energies of only a center point and/or one or more vertices, which have not been calculated in the previous steps, among the center point and vertices in the search pattern, and step 20 is performed to compare the error energies of center point in the search pattern with one or more vertices in the search pattern, which have been calculated in step 10 (in order to minimize procedures for calculating error energies and designating a candidate point).

In addition, calculations of the error energies according to an exemplary embodiment of the present invention are achieved through the calculation of the Sum of Absolute Difference (SAD) so that the present invention can be easily implemented.

Although the exemplary embodiment of the present invention is described for the case where the calculation of the error energies is achieved through the calculation of Sum of Absolute Difference, the present invention is not limited thereto. For example, the calculation of the error energies may be achieved by a mean square difference (MSD) scheme, a pixel difference classification (PDC) scheme, an integral projection (IP) scheme, etc.

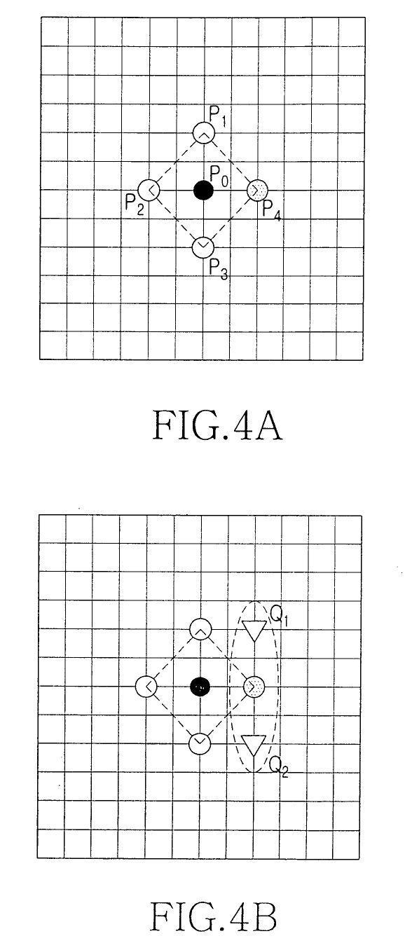

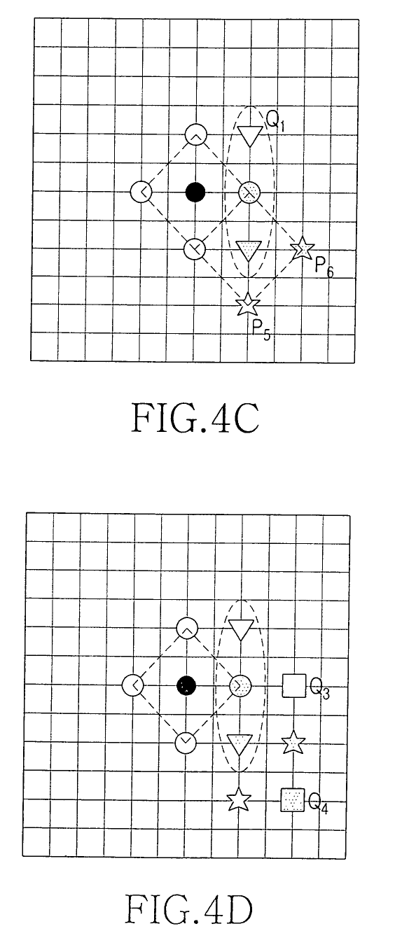

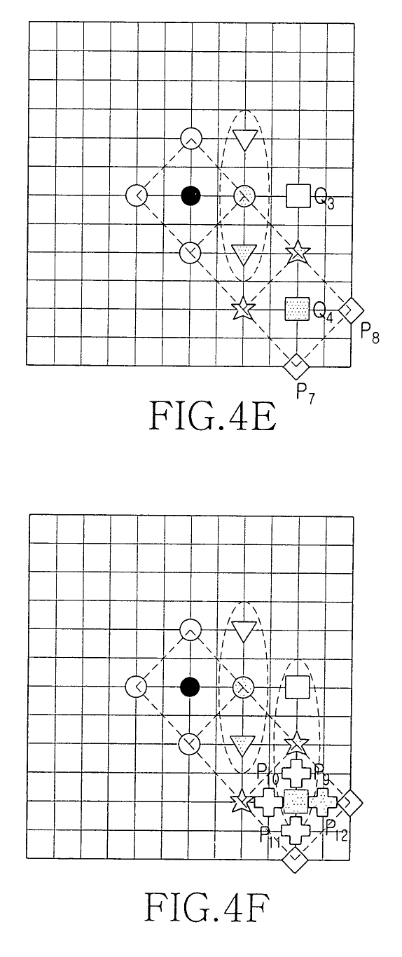

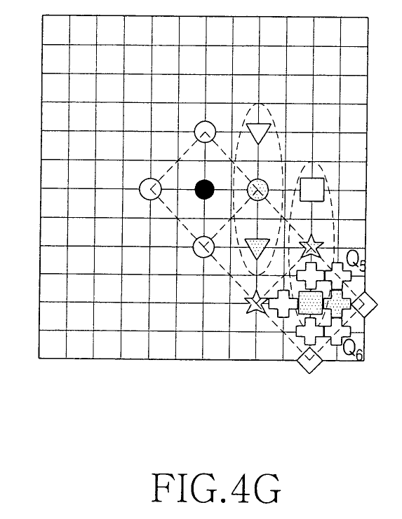

Hereinafter, a procedure of searching a moving point of a motion vector in a search window will be described with reference to the aforementioned motion vector search method and FIGS. 4A to 4G.

According to an exemplary embodiment of the present invention, the levels of error energies below are assumed as shown Equation 1.

Levels of Error Energies: P₀>P₁>P₂>P₃>P₄>Q₁>Q₂>P₅>P₆>P₇>P₈>Q₃>Q₄>P₉>P₁₀>P₁₁>Q₅>Q₆>P₁₂ Equation 1

In Equation 1, P₀ represents the energy of a center point, P₁ represents the energy of a first vertex, P₂ represents the energy of a second vertex, P₃ represents the energy of a third vertex, P₄ represents the energy of a fourth vertex, P₅ represents the energy of a fifth vertex, P₆ represents the energy of a sixth vertex, P₇ represents the energy of a seventh vertex, P₈ represents the energy of an eighth vertex, P₉ represents the energy of a ninth vertex, P₁₀ represents the energy of a tenth vertex, P₁₁ represents the energy of an eleventh vertex, P₁₂ represents the energy of a twelfth vertex, Q₁ represents the energy of a first neighboring point, Q₂ represents the energy of a second neighboring point, Q₃ represents the energy of a third neighboring point, Q₄ represents the energy of a fourth neighboring point, Q₅ represents the energy of a fifth neighboring point, and Q₆ represents the energy of a sixth neighboring point.

First, in step 10, the error energies of the center point P₀ and vertices P₁, P₂, P₃ and P₄ in a search pattern with respect to the origin of a search window are calculated (see FIG. 4A). Referring to step 10, the error energy of the fourth vertex P₄ among the five points is the lowest. Therefore, in the following step 20, the fourth vertex P₄ is designated as a first motion vector candidate point. Since the first motion vector candidate point designated in step 20 does not correspond to the center point of the search pattern (step 21-N), the error energies of the neighboring points Q₁ and Q₂ with respect to the fourth vertex P₄ are calculated in step 30 (see FIG. 4B). Then, since the error energy of the second neighboring point Q₂ is relatively lower than those of the fourth vertex P₄ and first neighboring point Q₁, the second neighboring point Q₂ is designated as a second motion vector candidate point. Herein, since the point designated as the second motion vector candidate point does not correspond to any vertex in the search pattern (step 41-N), step 10 is again performed. That is, the error energies of the vertices P₃, P₄, P₅ and P₆ in a search pattern with respect to the second motion vector candidate point (i.e., the second neighboring point Q₂) are calculated (see FIG. 4C). In this case, since the error energies of the third and fourth vertices P₃ and P₄ have been calculated in the previous step 10, the error energies of the third and fourth vertices P₃ and P₄ are not calculated, and only the error energies of the fifth and sixth vertices P₅ and P₆ are calculated.

Next, step 20 is performed again. In step 20, the error energy of the second motion vector candidate point (i.e., the second neighboring point Q₂) which is the center point of the search pattern is compared with those of the fifth and sixth vertices P₅ and P₆ calculated in step 10, and thus the sixth vertex P₆ having the lowest error energy is designated as a third motion vector candidate point. Then, since the error energy of the third motion vector candidate point (the sixth vertex P₆) is relatively lower than that of the second motion vector candidate point (i.e., the second neighboring point Q₂), which is the center point of the search pattern (step 21-N), step 30 is performed again, in which step the error energies of the neighboring points Q₃ and Q₄ of the sixth vertex P₆ are calculated (see FIG. 4D). In this case, since the error energy of the fourth neighboring point Q₄ is relatively lower than that of the sixth vertex P₆ which is the third motion vector candidate point, step 40 is again performed in which the neighboring point Q₄ is designated as a fourth motion vector candidate point. Then, since the fourth motion vector candidate point does not correspond to any vertex in the search pattern (step 41-N), step 10 is performed again. That is, the error energies of the vertices P₅, P₆, P₇ and P₈ in a search pattern with respect to the fourth neighboring point Q₄ are calculated (see FIG. 4E). Next, step 20 is performed. In step 20, the error energy of the fourth motion vector candidate point (i.e., the fourth neighboring point Q₄), which is the center point of the search pattern, is compared with those of the fifth and sixth vertices P₇ and P₈ calculated in step 10, and a point having the lowest error energy is designated as a fifth motion vector candidate point. Herein, the point designated as the fifth motion vector candidate point is identical to the fourth motion vector candidate point. Then, since the fifth motion vector candidate point corresponds to the center point of the search pattern (step 21-Y), step 50 of calculating the error energies of vertices P₉, P₁₀, P₁₁ and P₁₂ in a reduced search pattern with respect to the fourth neighboring point Q₄ is performed (see FIG. 4F). Next, since the error energy of the twelfth vertex P₁₂ is the lowest as a result of the calculation, the twelfth vertex P₁₂ is designated as a sixth motion vector candidate point in step 60. Then, since the point designated as the sixth motion vector candidate point does not correspond to the center point of the search pattern (step 61-N), the error energies of neighboring points Q₅ and Q₆ of the sixth motion vector candidate point are calculated in step 70 (see FIG. 4G). Next, according to a result of the calculation, the twelfth vertex P₁₂ designated as the sixth motion vector candidate point is designated as a seventh motion vector candidate point in step 80. Consequently, the error energy of the point (i.e., the twelfth vertex P₁₂) designated as the seventh motion vector candidate point is relatively lower than those of the neighboring points Q₅ and Q₆ (step 81-Y), so that finally, the point (i.e., twelfth vertex P₁₂) is determined as a moving point of a motion vector in step 100.

In order to compare the motion vector search method according to the present invention with a conventional search method, the following examinations were performed.

In the examinations, videos containing the same frames are encoded by means of an H.264 encoder, in which the examinations were established for the ME/MC unit 120 to use different motion vector search methods in an inter mode, as shown in Table 1. Also, the coordinates of motion vectors to be searched for on the basis of an origin are set to be different depending on examinations. In addition, the numbers of calculations of the error energies of points, which were performed until the search for a motion vector was completed, starting from the origin, in a search window, were checked.

TABLE 1

| | | Motion vector | Number of |
|---|---|---|---|
| | | to be searched | times of |
| | Search method | for | calculation |
| Comparison | Diamond search method | (2, 0) | 18 |
| Ex. 1 | | | |
| Comparison | Adaptive multimode search | (2, 0) | 11 |
| Ex. 2 | method | | |
| Embodiment 1 | Search method of the | (2, 0) | 12 |
| | present invention | | |
| Comparison | Diamond search method | (2, −2) | 22 |
| Ex. 3 | | | |
| Comparison | Adaptive multimode search | (2, −2) | 17 |
| Ex. 4 | method | | |
| Embodiment 2 | Search method of the | (2, −2) | 13 |
| | present invention | | |
| Comparison | Diamond search method | (3, −2) | 22 |
| Ex. 5 | | | |
| Comparison | Adaptive multimode search | (3, −2) | 21 |
| Ex. 6 | method | | |
| Embodiment 3 | Search method of the | (3, −2) | 15 |
| | present invention | | |

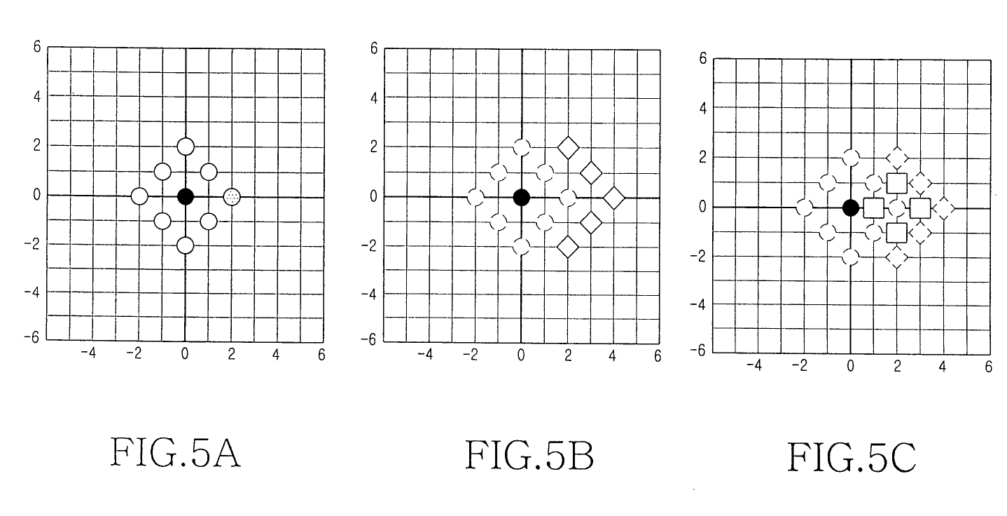

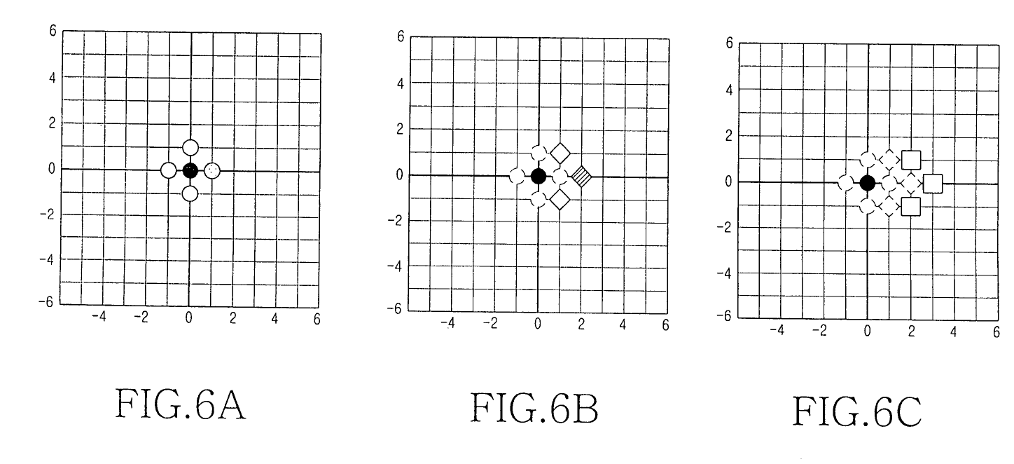

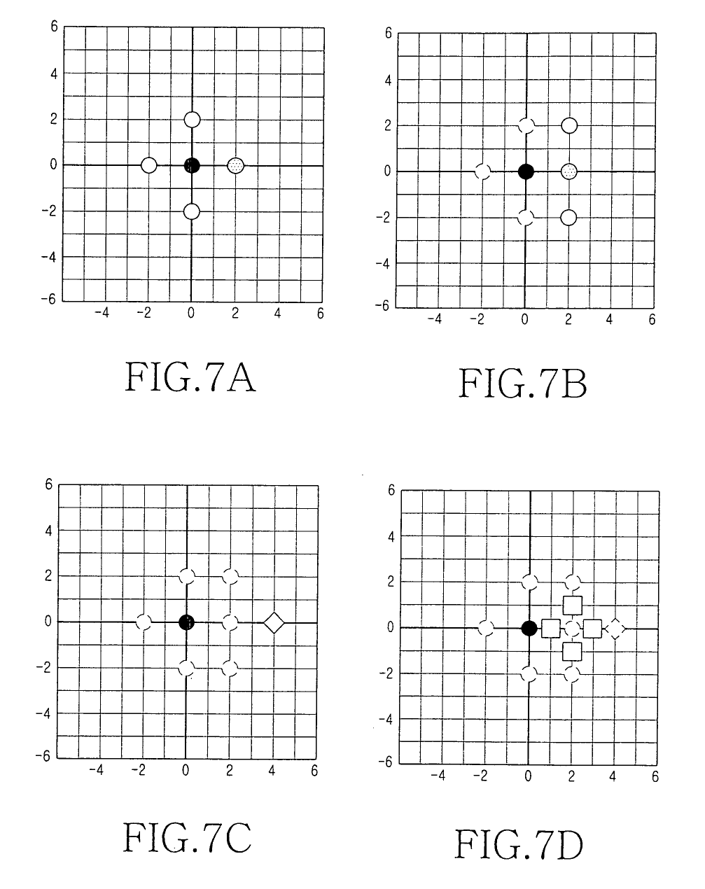

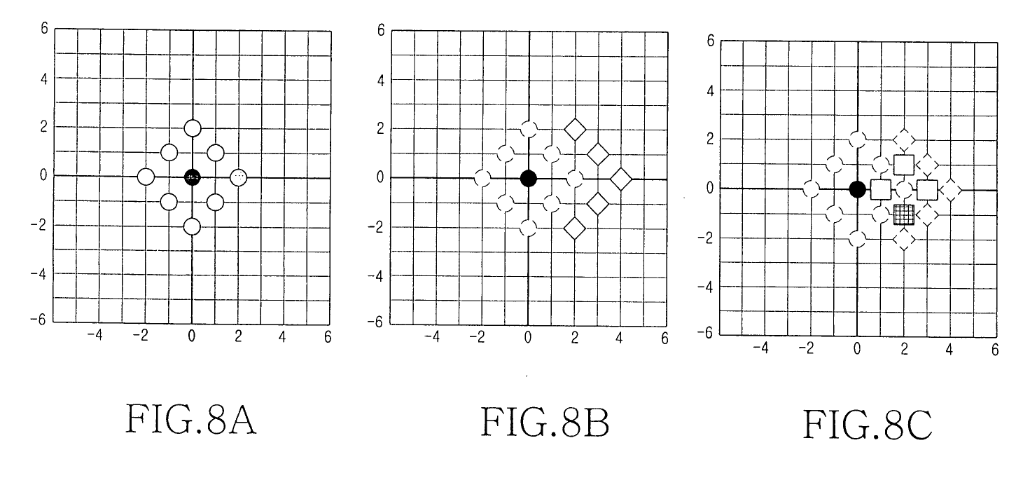

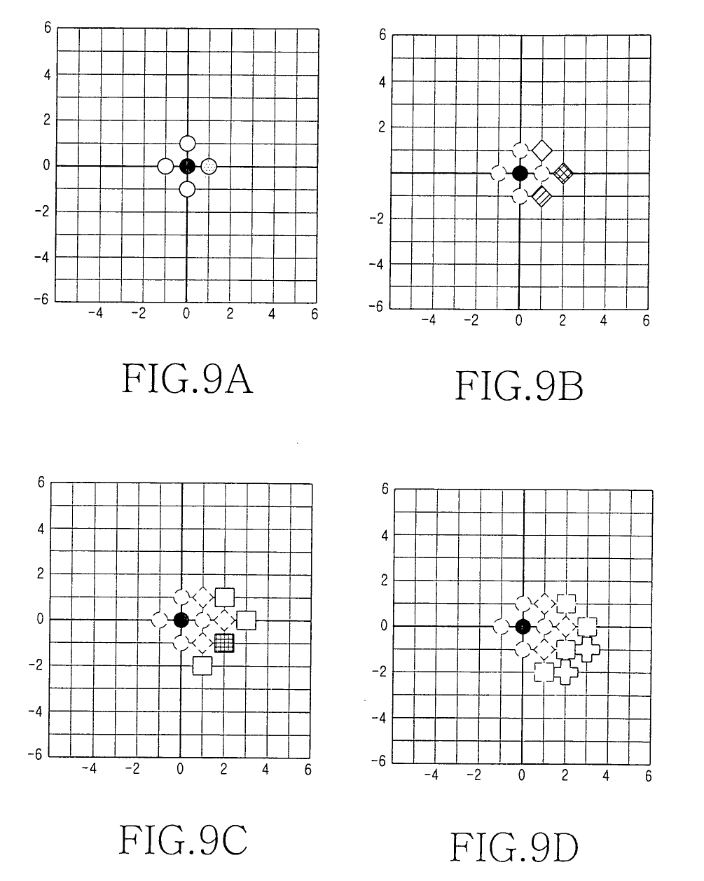

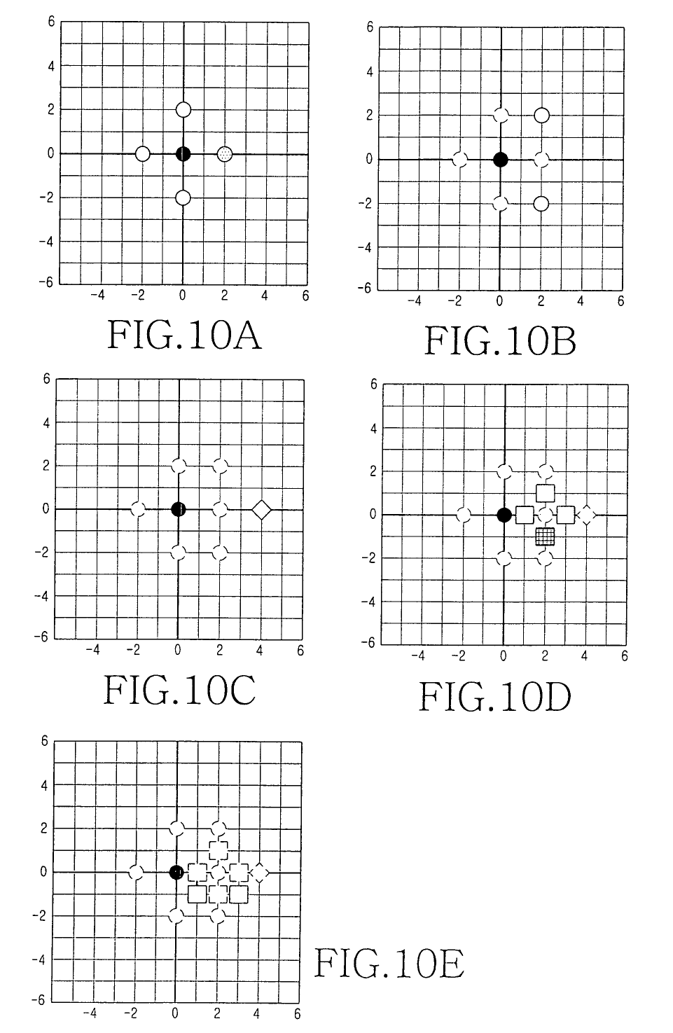

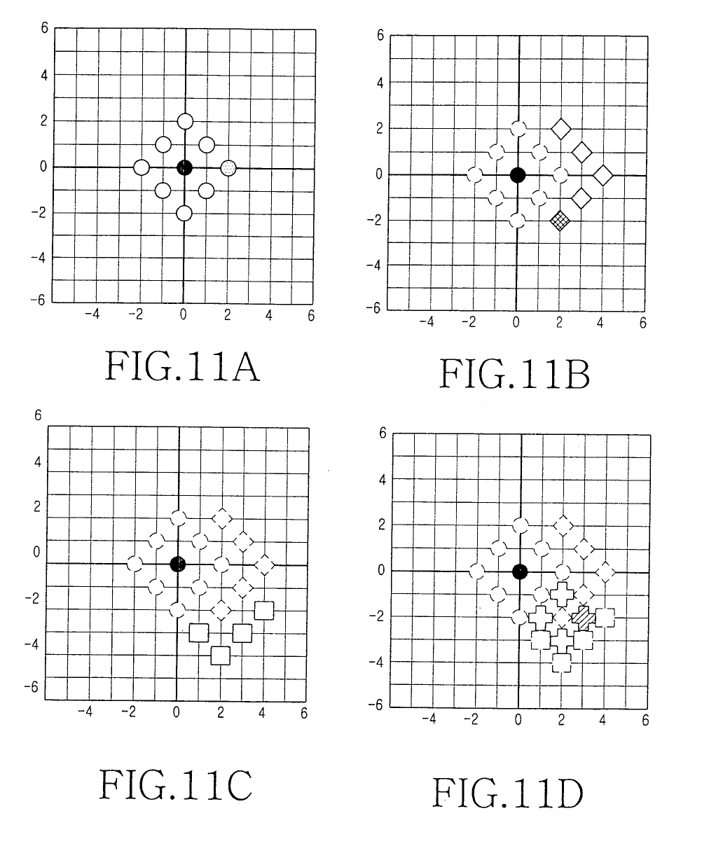

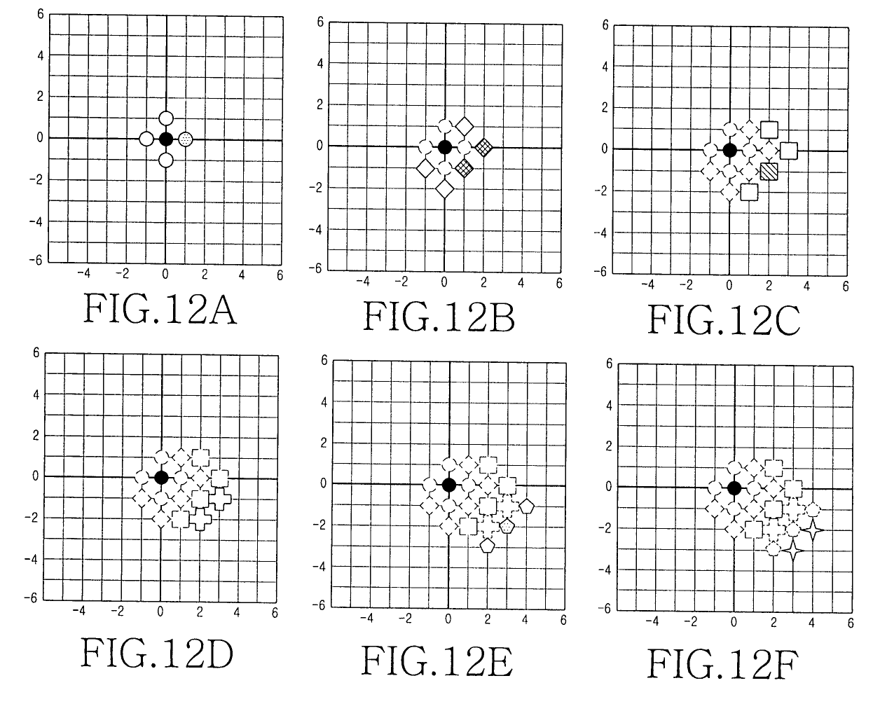

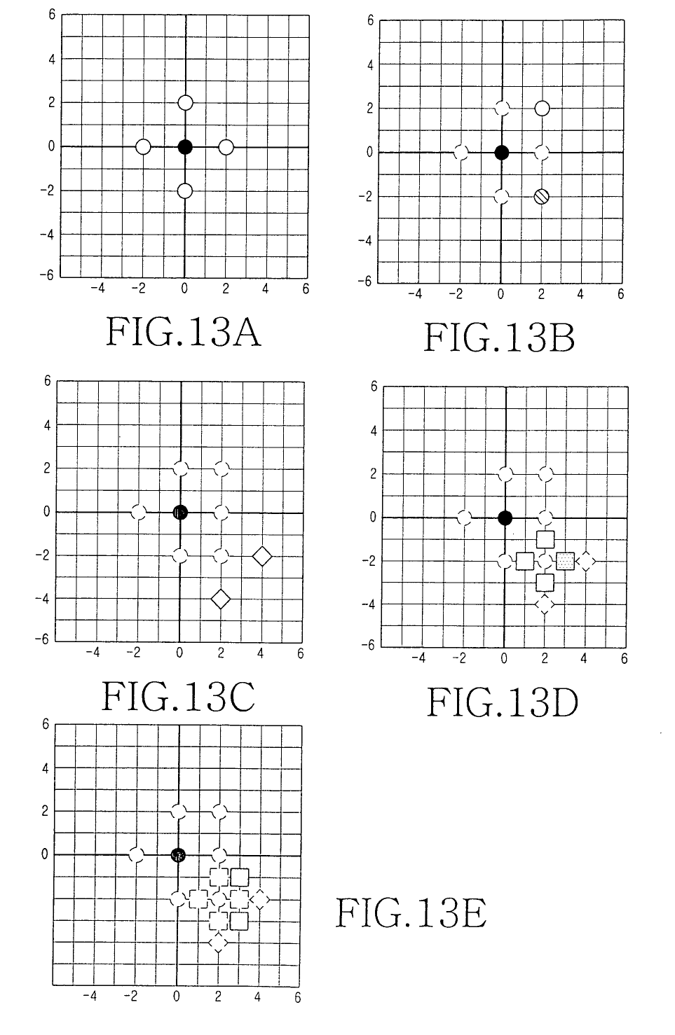

FIGS. 5A to 5C are examples of views illustrating step-by-step a search procedure according to Comparison Example 1, FIGS. 6A to 6C are examples of views illustrating step-by-step a search procedure according to Comparison Example 2, and FIGS. 7A to 7D are examples of views illustrating step-by-step a search procedure according to a first embodiment of the present invention. FIGS. 8A to 8C are examples of views illustrating step-by-step a search procedure according to Comparison Example 3, FIGS. 9A to 9D are examples of views illustrating step-by-step a search procedure according to Comparison Example 4, and FIGS. 10A to 10E are examples of views illustrating step-by-step a search procedure according to a second embodiment of the present invention. FIGS. 11A to 11D are examples of views illustrating step-by-step a search procedure according to Comparison Example 5, FIGS. 12A to 12F are examples of views illustrating step-by-step a search procedure according to Comparison Example 6, and FIGS. 13A to 13E are views illustrating step-by-step a search procedure according to a third embodiment of the present invention.

Referring to the drawings and Table 1, it can be understood that Comparison Example 1 requires a relatively higher number of times of error energy calculation, as compared with Comparison Example 2 and the first embodiment of the present invention, and Comparison Example 2 and the first embodiment of the present invention requires similar numbers of times of error energy calculation until having completed the search for a motion vector (2, 0). Comparison Example 3, Comparison Example 4, and the second embodiment of the present invention were established to have a relatively longer search length for a motion vector, as compared with Comparison Example 1, Comparison Example 2, and the first embodiment of the present invention. Thus, it can be understood that the second embodiment of the present invention requires a relatively lower number of times of error energy calculation, as compared with Comparison Example 3 and Comparison Example 4. Also, Comparison Example 5, Comparison Example 6, and the third embodiment of the present invention were established to have a relatively longer search length for a motion vector, as compared with Comparison Example 3, Comparison Example 4, and the second embodiment of the present invention. Thus, it can be understood that the third embodiment of the present invention requires a relatively lower number of times of error energy calculation energies, as compared with Comparison Example 5 and Comparison Example 6, and the difference of the numbers of calculation times between the third embodiment of the present invention and the Comparison examples increases, as compared with the case of Comparison Example 3 and Example 4, and the second embodiment of the present invention.

Consequently, when a motion vector is searched for using a motion vector search method according to the present invention, the search for the motion vector can be completed with a relatively lower amount of calculation, as compared with a conventional search method.

While the present invention has been shown and described for the case where the motion vector search method is applied to an H.264/AVC video encoder device, the present invention is not limited thereto. For example, the present invention can be applied to various means for encoding video data.

As described above, the motion vector search method according to the present invention can reduce the number of times an error energy calculation is performed during execution of a motion vector search procedure, thereby enabling rapid and efficient searching for a motion vector. In addition, the search pattern used in the motion vector search method according to the present invention has a wide search range, so that it is possible to exactly search for a motion vector.

What is claimed is:

1. A method for obtaining a motion vector (MV) of a search window established in a current frame in a procedure that estimates a motion of a subsequent image frame, the method comprising:
(a) individually calculating error energies of a center point and vertices of a search pattern (SP) in a search window used in a previous frame, with respect to a center of a search window established in the current frame;
(b) designating a motion vector candidate point based on the calculated error energies of one of (a) and (e);
(c) when the designated motion vector candidate point corresponds to one of vertices of the search pattern, calculating error energies of a pair of neighboring points which are adjacent to the vertex designated as the motion vector candidate point;
(d) re-establishing a motion vector candidate point based on calculated error energies of the calculation performed in (c);
(e) when one of the neighboring points is established as a motion vector candidate point in (d), calculating error energies of vertices in a search pattern with respect to a neighboring point designated as the motion vector candidate point; and
(f) either when the motion vector candidate point designated in (b) corresponds to the center point, or when the motion vector candidate point re-established in (d) corresponds to a vertex in the search pattern, determining one of the center point or the vertex as a moving point of the motion vector.

2. The method as claimed in claim 1, wherein, (b) further comprises comparing levels of error energies of the center point and the vertices; and designating a point having a lowest error energy as a result of the comparison as the motion vector candidate point.

3. The method as claimed in claim 1, wherein (d) further comprises comparing levels of error energies of the vertex and the pair of neighboring points; and re-establishing a point having a lowest error energy as the motion vector candidate point.

4. The method as claimed in claim 1, further comprising, after (b) performing:
(g) reducing a range of the search pattern with respect to the center point designated as a motion vector candidate point, and calculating error energies of vertices in the reduced search pattern;
(h) re-designating a point having a lowest error energy as a motion vector candidate point, based on a result of calculation of error energies performed in (g) or (k);
(i) when the re-designated motion vector candidate point corresponds to one of vertices, calculating error energies of a pair of neighboring points which are adjacent to the vertex designated as the motion vector candidate point;
(j) re-establishing a motion vector candidate point based on a result of the calculation performed in (i);
(k) when one of the neighboring points is re-established as a motion vector candidate point in (j), calculating error energies of vertices in a reduced search pattern with respect to the neighboring point designated as the motion vector candidate point; and
(l) either when the motion vector candidate point designated in (h) corresponds to the center point of the reduced search pattern, or when the motion vector candidate point re-designated in (j) corresponds to a vertex in the reduced search pattern, determining the center point or the vertex as a moving point of the motion vector.

5. The method as claimed in claim 4, wherein, (h) further comprises, compares levels of error energies of the center point and vertices in a reduced search pattern, which have been calculated in (g) or (k); and designating a point having a lowest error energy as the motion vector candidate point.

6. The method as claimed in claim 4, wherein, (j) further comprises, comparing levels of error energies of the vertex and the pair of neighboring points which have been calculated in step (i); and designating a point having a lowest error energy is designated as the motion vector candidate point.

7. The method as claimed in claim 1, wherein, in (b) further comprises, comparing an error energy of the center point in the search pattern with an error energy of a vertex which has been newly calculated in (a) or (e); and designating a motion vector candidate point therefrom based on a result of the comparison.

8. The method as claimed in claim 4, wherein, (h) further comprises, comparing an error energy of the center point of the reduced search pattern with an error energy of a vertex which has been newly calculated in (g) or (k); and designating a motion vector candidate point therefrom based on a result of the comparison.

9. The method as claimed in claim 1, wherein the search pattern comprises the center point and at least two pairs of vertices, in which two vertices comprising each vertex pair face each other with respect to the center point, and are positioned such that a line connecting one pair of vertices and a line connecting the other pair of vertices are perpendicular to each other at the center point.

10. The method as claimed in claim 1, wherein the search pattern comprises vertices of a large diamond search pattern (LDSP).

11. The method as claimed in claim 4, wherein the reduced search pattern comprises a small diamond search pattern (SDSP).

12. The method as claimed in claim 1, wherein the pair of neighboring points, which are adjacent to the center point, correspond to points horizontally or vertically displaced by a distance between the center point and the vertex, from vertexes adjacent to the vertex as a reference.

13. The method as claimed in claim 1, wherein the error energy corresponds to a Sum of Absolute Difference (SAD).
